(19) United States
(12) Patent Application Publication
(10) Pub. No.: US 2025/0048319 A1
(43) Pub. Date: Feb. 6, 2025

(54) TEST MECHANISM FOR ARTIFICIAL INTELLIGENCE/MACHINE LEARNING BASED POSITIONING ACCURACY VERIFICATION

(71) Applicant: Nokia Technologies Oy, Espoo (FI)

(72) Inventors: Deepa MALAPATI RAVINDRAIAH, Bangalore (IN); Fahad SYED MUHAMMAD, Massy (FR); Afef FEKI, Massy (FR); Dimitri GOLD, Espoo (FI); Muhammad Ikram ASHRAF, Espoo (FI)

(21) Appl. No.: 18/789,597

(22) Filed: Jul. 30, 2024

(30) Foreign Application Priority Data
Aug. 3, 2023 (IN) 202341052241

(51) Int. Cl. H04W 64/00; G06N 5/04

(52) U.S. Cl. CPC H04W 64/00; G06N 5/04

(57) ABSTRACT

Systems, methods, apparatuses, and computer program products for verifying positioning accuracy. One method may include transmitting, by testing equipment, a request to measure location coordinates to a device, receiving, by the testing equipment, from the device, a model inference comprising at least one location coordinate, and determining, by the testing equipment, whether a difference between the model inference and at least one ground truth is within a threshold value for a defined number of samples, wherein the at least one ground truth comprises at least one known location coordinate of a test point.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for verifying positioning accuracy.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, by testing equipment, a request to measure location coordinates to a device. The method may further include receiving, by the testing equipment, from the device, a model inference comprising at least one location coordinate. The method may further include determining, by the testing equipment, whether a difference between the model inference and at least one ground truth is within a threshold value for a defined number of samples. The at least one ground truth comprises at least one known location coordinate of a test point.

In accordance with certain example embodiments, an apparatus may include means for transmitting a request to measure location coordinates to a device. The apparatus may further include means for receiving from the device, a model inference comprising at least one location coordinate. The apparatus may further include means for determining whether a difference between the model inference and at least one ground truth is within a threshold value for a defined number of samples. The at least one ground truth comprises at least one known location coordinate of a test point.

In accordance with various example embodiments, a non-transitory computer readable medium may include program instructions that, when executed by an apparatus, cause the apparatus to perform at least a method. The method may include transmitting a request to measure location coordinates to a device. The method may further include receiving from the device, a model inference comprising at least one location coordinate. The method may further include determining whether a difference between the model inference and at least one ground truth is within a threshold value for a defined number of samples. The at least one ground truth comprises at least one known location coordinate of a test point.

In accordance with some example embodiments, a computer program product may perform a method. The method may include transmitting a request to measure location coordinates to a device. The method may further include receiving from the device, a model inference comprising at least one location coordinate. The method may further include determining whether a difference between the model inference and at least one ground truth is within a threshold value for a defined number of samples. The at least one ground truth comprises at least one known location coordinate of a test point.

In accordance with certain example embodiments, an apparatus may include at least one processor and at least one memory storing instructions that, when executed by the at least one processor, cause the apparatus at least to transmit a request to measure location coordinates to a device. The at least one memory and instructions, when executed by the at least one processor, may further cause the apparatus at least to receive from the device, a model inference comprising at least one location coordinate. The at least one memory and instructions, when executed by the at least one processor, may further cause the apparatus at least to determine whether a difference between the model inference and at least one ground truth is within a threshold value for a defined number of samples. The at least one ground truth comprises at least one known location coordinate of a test point.

In accordance with various example embodiments, an apparatus may include transmitting circuitry configured to perform transmitting a request to measure location coordinates to a device. The apparatus may further include receiving circuitry configured to perform receiving from the device, a model inference comprising at least one location coordinate. The apparatus may further include determining circuitry configured to perform determining whether a difference between the model inference and at least one ground truth is within a threshold value for a defined number of samples. The at least one ground truth comprises at least one known location coordinate of a test point.

In accordance with some example embodiments, a method may include receiving, by a device, a request to measure location coordinates from testing equipment. The method may further include performing, by the device, one or more direct positioning measurements. The method may further include transmitting, by the device, a model inference comprising at least one location coordinate to the testing equipment.

In accordance with certain example embodiments, an apparatus may include means for receiving a request to measure location coordinates from testing equipment. The apparatus may further include means for performing one or more direct positioning measurements. The apparatus may further include means for transmitting a model inference comprising at least one location coordinate to the testing equipment.

In accordance with various example embodiments, a non-transitory computer readable medium may include program instructions that, when executed by an apparatus, cause the apparatus to perform at least a method. The method may include receiving a request to measure location coordinates from testing equipment. The method may further include performing one or more direct positioning measurements. The method may further include transmitting a model inference comprising at least one location coordinate to the testing equipment.

In accordance with some example embodiments, a computer program product may perform a method. The method may include receiving a request to measure location coordinates from testing equipment. The method may further include performing one or more direct positioning measurements. The method may further include transmitting a model inference comprising at least one location coordinate to the testing equipment.

In accordance with certain example embodiments, an apparatus may include at least one processor and at least one memory storing instructions that, when executed by the at least one processor, cause the apparatus at least to receive a request to measure location coordinates from testing equipment. The at least one memory and instructions, when executed by the at least one processor, may further cause the apparatus at least to perform one or more direct positioning measurements. The at least one memory and instructions, when executed by the at least one processor, may further cause the apparatus at least to transmit a model inference comprising at least one location coordinate to the testing equipment.

In accordance with various example embodiments, an apparatus may include receiving circuitry configured to perform receiving a request to measure location coordinates from testing equipment. The apparatus may further include performing circuitry configured to perform performing one or more direct positioning measurements. The apparatus may further include transmitting circuitry configured to perform transmitting a model inference comprising at least one location coordinate to the testing equipment.

### BRIEF DESCRIPTION OF THE DRAWINGS

For a proper understanding of example embodiments, reference should be made to the accompanying drawings, wherein:

FIG. 1 illustrates an example of a test grid according to certain example embodiments;

FIG. 2 illustrates an example of a flow diagram of a method according to some example embodiments;

FIG. 3 illustrates an example of a signaling diagram according to various example embodiments;

FIG. 4 illustrates an example of test scenarios with test positions according to certain example embodiments;

FIG. 5 illustrates an example of mapping in between test positions and radio signal parameters according to some example embodiments;

FIG. 6 illustrates an example of a test setup with multiple signals with TRP-specific parameters are transmitted (i.e., multiplexed) through the radio probes according to various example embodiments;

FIG. 7 illustrates an example of a signaling diagram according to certain example embodiments;

FIG. 8 illustrates an example of a flow diagram of a method according to various example embodiments;

FIG. 9 illustrates an example of a flow diagram of a method according to various example embodiments;

FIG. 10 illustrates an example of various network devices according to some example embodiments; and

FIG. 11 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for verifying positioning accuracy is not intended to limit the scope of certain example embodiments, but is instead representative of selected example embodiments.

3GPP defines test mechanisms for location estimation and latency for global navigation satellite system (GNSS) based positioning. Such test mechanisms may relate to varies satellites, and may rely on GNSS measurements. However, there are currently no defined test mechanisms to verify the positioning accuracy of the UE for positioning reference signal (PRS) based measurements. For example, PRS may be transmitted by a transmission reception point (TRP) in a network. Furthermore, one challenge in testing positioning accuracy is extracting the ground truth of the actual location coordinates.

Certain example embodiments described herein may have various benefits and/or advantages to overcome the disadvantages described above. For example, certain example embodiments may define test mechanisms to check the positioning accuracy of UE-based direct AI/ML positioning, which may rely on PRS transmissions from test equipment (TE) or NE. Thus, certain example embodiments discussed below are directed to improvements in computer-related technology.

Some example embodiments discussed below relate to validating and testing a given UE-based AI/ML model. Specifically, an AI/ML model for positioning (e.g., positioning estimation) may need to be tested and validated against labelled data in order to increase confidence on the training data and the model output. Such labels may be trusted by default and/or be represented by the ground truth. For example, for UE based direct AI/ML positioning, positioning accuracy may be selected as a test metric/key performance indicator (KPI) for performance evaluation of inferences, particularly for proprietary AI/ML models deployed at the UE for positioning purposes. In addition, the network may be unaware of details about the UE-based AI/ML model, including its positioning accuracy and/or performance. However, the network may need to monitor performance KPIs of the AI/ML model in order to initiate LCM based procedures (e.g., model reselection, updating, switching, deactivation, etc.).

Current 5G/NR requirements assume that the UE reports measurements (e.g., reference signal receive power (RSRP)), and that a location management function (LMF) determines the position. Thus, legacy requirements may be based upon the accuracy and latency of measurements performed and reported by the UE, rather than the actual position. In cases of direct positioning, the UE may no longer need to report measurements (e.g., UE only reports position estimate). Thus, legacy requirements may be inapplicable, and no requirements nor tests exist to verify the direct UE-based positioning functionality (e.g., positioning accuracy). Various legacy positioning methods (e.g., assisted GNSS (A-GNSS)) may have performance requirements on location estimation and latency for GNSS based positioning.

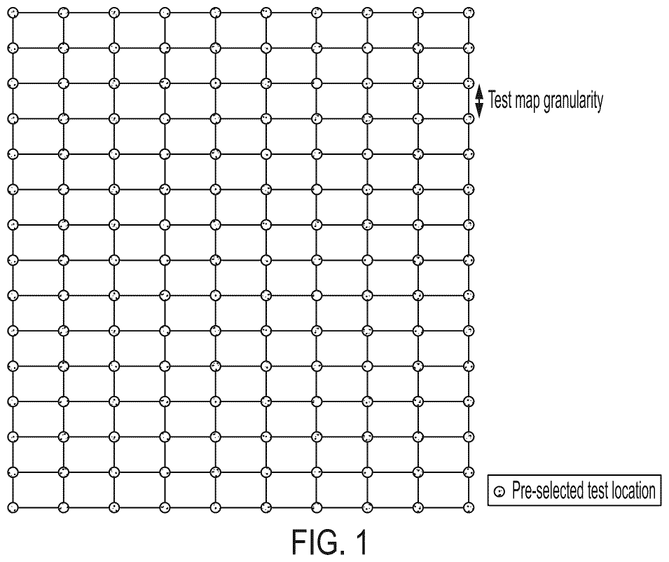

Various example embodiments of the test procedure described herein for verifying the positioning accuracy for the UE based AI/ML model may include using test equipment (TE) and a device under test (DUT), which may also be a positioning reference unit (PRU). Such tests may be performed within a test grid, such as that illustrated in FIG. 1. Such as test grid represents a test area including a set of points with known location coordinates. Alternatively, a PRU may be placed at each point within the test grid to derive the location coordinates. The size of the test area, and the spacing between the points, may be in terms of meters or centimeters, depending upon the test requirements.

The TE may configure the DUT with any required configurations, including the AI/ML model whose performance is to be verified. The DUT may then be placed at the center or an edge of the test grid; when the test procedure begins, the DUT may remain at the initial location for n seconds. While at this location, the DUT may compute the location coordinates based on an AI/ML model inference, and transmit those coordinates to the TE. The TE (or other validation entity) may compare the location coordinates reported by the DUT with the actual location coordinates, and generate/display the results (e.g., in a table and/or graph). The comparison result may be input to the AI/ML model for calibration purposes.

The DUT may also move within the test grid in a predetermined trajectory, and repeat the aforementioned steps. For example, the DUT may be held by a person, or affixed to a robot or drone, in order to move within the test grid in a controlled manner during testing. If the positioning accuracy on an average (or based on pre-configured threshold) is within the defined limits, declare the test as “PASSED;” other, the test may be declared as “FAILED.”

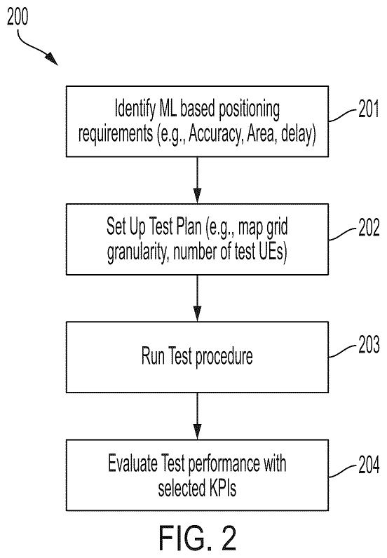

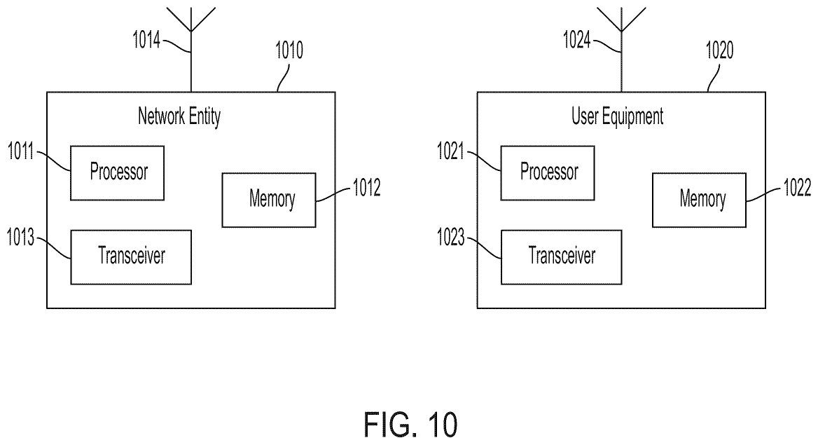

In general, FIG. 2 illustrates an example of a flow diagram of a method 200 according to some example embodiments described herein that may be performed by a device similar to any of NE 1010 or UE 1020, as illustrated in FIG. 10, according to certain example embodiments. Specifically, at step 201, the method may include identifying one or more requirements of a trained ML based positioning model or functionality under consideration. Such a trained ML model may be associated with a set of requirements, assumptions, parameters, inputs (e.g., RSRP, RSTD, number of TRPs, CIR), network configuration (e.g., presence and period of reference signals) targeted positioning accuracy and optionally any delay/time duration to complete the test procedure.

At step 202, the method may include mapping the requirements and assumptions identified at step 201 to a test plan. One or more predefined rules can be applied to derive the tailored test plan. For example, a first rule could define a required positioning accuracy to select a test grid granularity. Grid granularity (e.g., in meters) should be lower or at least equal to the targeted positioning accuracy of the trained model. In another example, a test duration/delay requirement rule may be used to select a number of DUT and map them to the test grid (e.g., for an imperative low test duration higher number of test UEs may be needed to process in parallel and realize in shorter time the complete test). In yet another example, a third rule may define a DUT trajectory in the test (e.g., what will be sequence of DUT positions in the test, and how the transmitted signals are changed if needed).

At step 203, a test procedure may be executed that follows the test plan established at step 202. At step 204, test results may be analyzed, and the performance may be derived following selected KPIs (e.g., 90% percentile of achieved positioning accuracy) and/or a determination may be made whether the test has passed or failed.

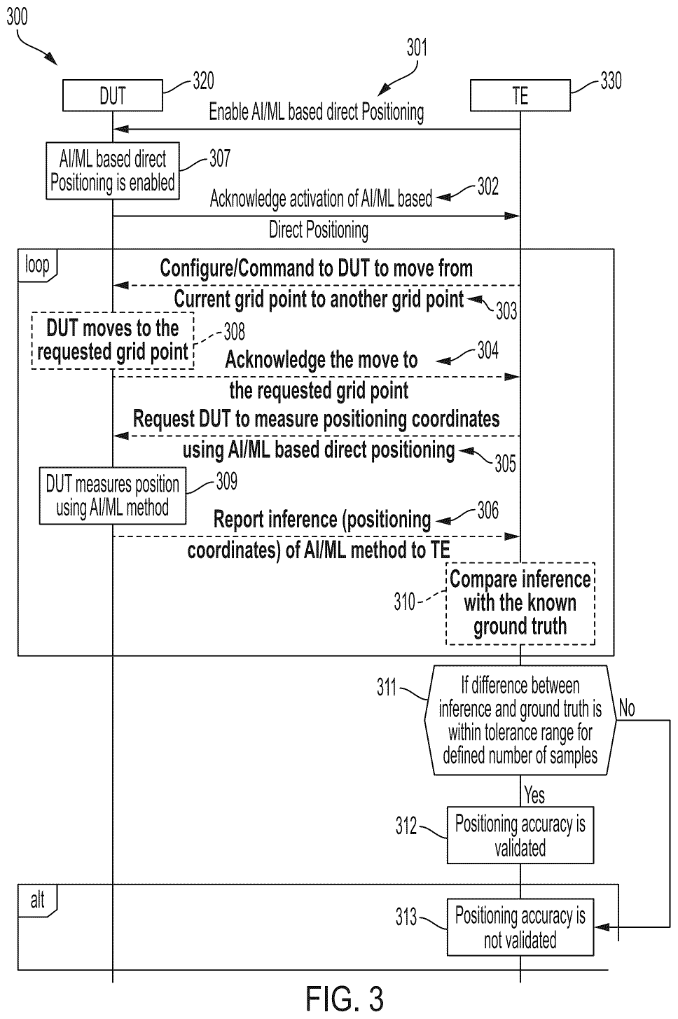

FIG. 3 illustrates an example of a signaling diagram 300 depicting for evaluating positioning accuracy of direct AI/ML based positioning. Any of DUT 320 and TE 330 may be similar to NE 1010 or UE 1020, as illustrated in FIG. 10, according to certain example embodiments.

At operation 301, TE 330 may transmit to DUT 320 a command to enable AI/ML based direct positioning.

At operation 302, DUT 320 may enable AI/ML based direct positioning.

At operation 303, DUT 320 may transmit to TE 330 a command to acknowledge activation of AI/ML based direct positioning.

At operation 304, DUT 320 may transmit to TE 330 a command to move from a current test point to another test point. This command may or may not be transmitted over an air interface, and/or may or may not be an application layer level command.

At operation 305, in response to the command received at operation 304, DUT 320 may move to the test point indicated by TE 330.

At operation 306, DUT 320 may transmit to TE 330 an acknowledgement command confirming DUT 320 has moved to the indicated test point. This command may or may not be transmitted over an air interface, and/or may or may not be an application layer level command. It is noted that operations 304-306 are optional if the trajectory of DUT 320 and the time duration to stay at each test point are pre-configured and available at DUT 320.

At operation 307, TE 330 may transmit to DUT 320 a request to measure location coordinates using AI/ML based direct positioning.

At operation 308, DUT 320 may perform AI/ML based direct positioning measurements.

At operation 309, DUT 320 may report to TE 330 the AI/ML model inference (i.e., location coordinates).

At operation 310, TE 330 may compare the inference with the known ground truth (i.e., the known location coordinate of the test point).

At operation 311, TE 330 may determine whether the difference between the inference and the ground truth is within the acceptable range for defined number of samples. If yes, at operation 312, TE 330 may validate the positioning accuracy. Otherwise, if it is not within the acceptable range, TE 330 may not perform the validation. Operations 304-311 may be repeated.

In some example embodiments, the operations illustrated in FIG. 3 may be performed without the usage of a test grid. Instead, GNSS based location coordinates or any other non AI/ML methods may be used as ground truth for comparison of the AI/ML model inference.

In various example embodiments, TE 330 may provide the monitoring data which may include relevant inputs (e.g., ground truth location of DUT 320) to DUT 320 to perform model monitoring. DUT 320 may validate and test its AI/ML model using the data received from TE 330, and may calculate a metric “delta” that indicates the performance of its AI/ML model performance, such as based on prediction accuracy (e.g., mean square error (MSE) between the predicted measurements (i.e., UE position) and ground truths (e.g., DUT 320 acquired from TE 330)).

Certain example embodiments may include test generalizations of the model, wherein the input type/dimension may be similar to the training data set. For example, TE 330 may send a command to DUT 320 to move to a next test point. An alternative method may include using a pre-configured test plan (e.g., DUT 320 may move across different test points based on the test plan without the need for sending the command from TE 330 to DUT 320 every time (i.e., operations 304-306). The time period to stay at each test point should be indicated to DUT 320 at operation 301 or 304 before starting the positioning measurements. This test may be performed with two UEs or multiple SIM (MUSIM) UE with 2 SIMs, wherein UE1/SIM1 may be configured with an AI/ML model enabled, and the other UE2/SIM2 may be configured with an AI/ML model disabled. Both UEs/SIMs may be initially placed at the same location, and they may move at the same time one operation at a time, as described above. TE 330 may compare the location coordinates of UE1 and UE2 for validating the positioning accuracy.

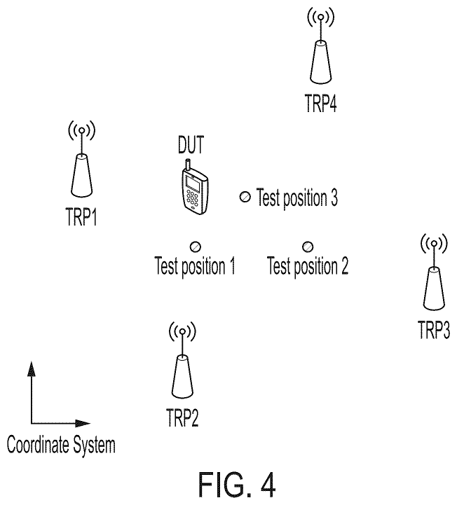

In certain example embodiments, a UE may remain static in the testing setup, but the transmission parameters of the radio signals (e.g., transmission occasions, Rx power and propagation/transmission delay) may be defined before each set of the test (i.e., per each expected location, based on the testing scenario). For example, DUT positioning accuracy may be tested in multiple locations, as shown in FIG. 4. Positions of the TRPs and test locations may be known or defined before the test execution (e.g., as in step 201 above).

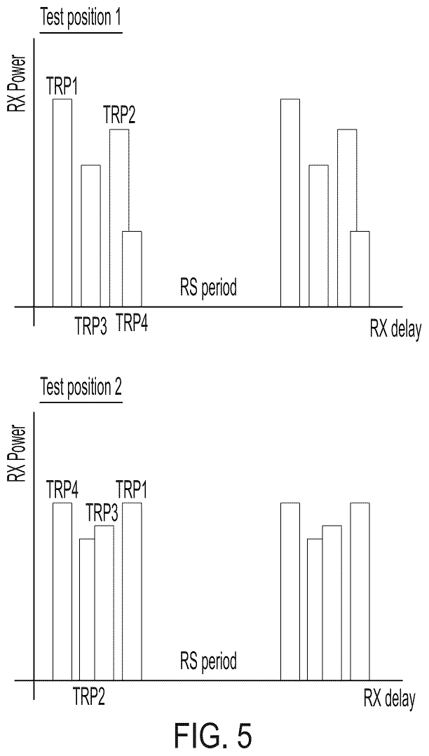

A DUT algorithm may define the position based on the measurements performed from different radio signal sources (e.g., from different TRPs/gNBs). Depending on the algorithm (e.g., ML functionality, AI/ML model, etc.) capabilities defined at step 201, different parameters may be taken into account, such as Rx power of reference signals (RS) (e.g., RSRP), time of arrival, angle of arrival, etc. There may be correspondence in between the radio signal parameters and the location. These parameters of the radio signals may be calculated based on the propagation models and/or environment, or taken from the field measurements. A mapping in between the test point location (i.e., coordinates) and radio signal characteristics may be established. FIG. 5 depicts an example where two parameters of signal power (e.g., RX power of positioning reference signals (PRS) or SSBs per TRP) and propagation delay may be considered.

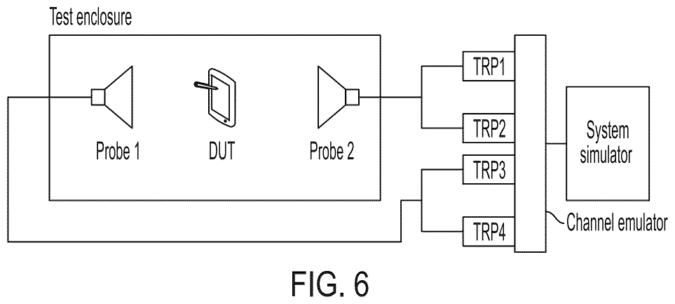

Emulation of a propagation environment may not require physical distribution of TRPs since there may be a significant distance in between the TRPs and UEs, but the size of the test setup may also be limited. Moreover, the number of TRPs/probes/radio sources may be limited as well, while in practice, the UE may need to measure many sources for accurate positioning. Thus, in the test setup, transmission from multiple real TRPs (i.e., TRPs that the UE is able to measure) may/can be mapped to a smaller number of probes (i.e., physically implemented transmitters available in the testing setup). The number of probes may be limited, by the UE may need more TRPs than the number of probes to determine its location. The signals may correspond to a larger number of TRPs (e.g., with TRP-specific parameters) may be transmitted through a few probes. In such a way, the UE may be able to measure signals from many TRPs even though there are only few physical transmitters. The way of achieving this is demonstrated in the scheme from FIG. 6. In one example, the signals (e.g., PRS transmissions) with TRP-specific parameters (e.g., TX/RX power/attenuation, propagation delay/transmission time, etc.) may be multiplexed in time (i.e., signals are transmitted consecutively). In another example, TRP-specific signals may be combined via radio frequency (RF) components (e.g., radio signal combiners).

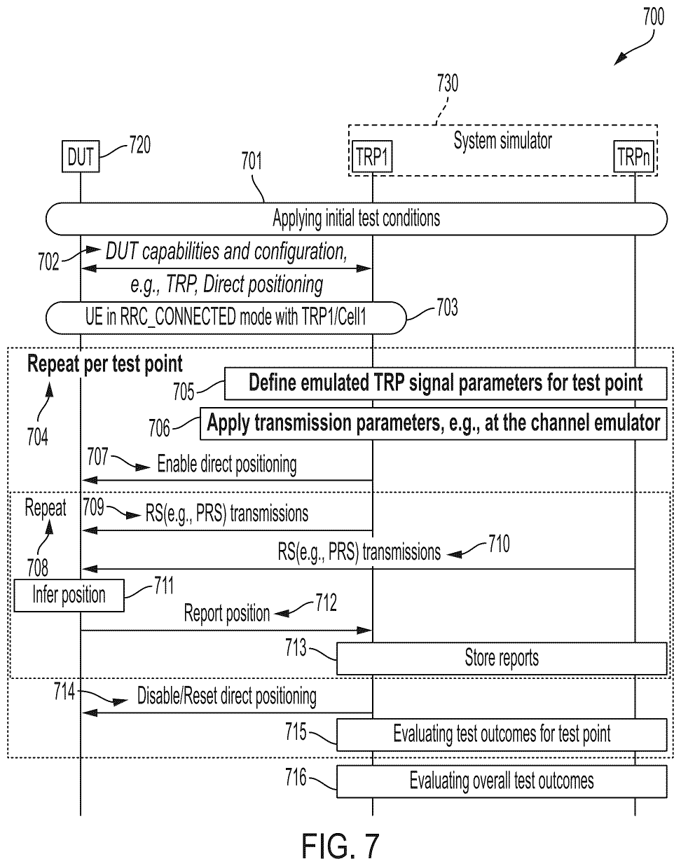

FIG. 7 illustrates an example of a signaling diagram 700 depicting for a direct positioning text sequence. Any of DUT 720 and TRP1-n 730 may be similar to NE 1010 or UE 1020, as illustrated in FIG. 10, according to certain example embodiments.

In general, operations 701-703 may be similar to steps 201-202 above, where the test plan is defined at step 201, and AI/ML based position prediction capabilities of DUT 720 are defined/verified at step 202 (e.g., model/functionality selection).

At operation 703, DUT 720 may stay in a connected model with the system simulator (SS) that may include multiple cells/gNBs/TRPs/access points. The connection may be established with Cell1/TRP1. Other TRPs may be used only to generate reference signals (RS, e.g., for positioning (PRS)) that can be used for positioning.

At operation 704, operations 705-713 may be repeated for each of the test points TRP1-n. For example, at operation 706, the corresponding signal generation/transmission parameters may be applied.

At operation 707, direct positioning functionality may be activated. Activation may also include an indication of a specific AI/ML functionality or AI/ML model if it supported by DUT 720. Activation/indication of the model may be also performed on the application level and/or through the specific testing interface.

At operation 714, the positioning functionality may be disabled so that the measurements in one test point would not impact the measurements in the other one.

At operation 715-716, TRP1-n may determine whether the test has passed or failed per test point and overall, respectively. For example, success criteria may include that the position inferred accuracy by DUT 720 stays within xx meters (e.g., 0.5 m) in yy % of reports.

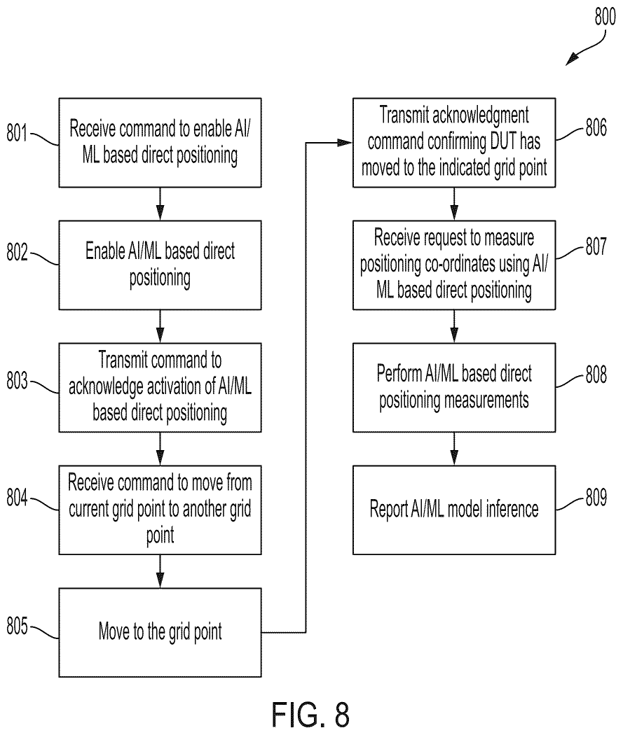

FIG. 8 illustrates an example of a flow diagram of a method 800 that may be performed by a DUT, such as NE 1010 or UE 1020, as illustrated in FIG. 10, according to certain example embodiments.

At step 801, the method may include receiving a command to enable AI/ML based direct positioning.

At step 802, the method may further include enabling AI/ML based direct positioning.

At step 803, the method may further include transmitting a command to acknowledge activation of AI/ML based direct positioning.

At step 804, the method may further include receiving a command to move from a current grid position to another grid position.

At step 805, the method may further include moving to the another grid position.

At step 806, the method may further include transmitting an acknowledgement command confirming the DUT has moved to the indicated grid position.

At step 807, the method may further include receiving a request to measure positioning coordinates using AI/ML based direct positioning.

At step 808, the method may further include performing AI/ML based direct positioning measurements.

At step 809, the method may further include reporting AI/ML model inference.

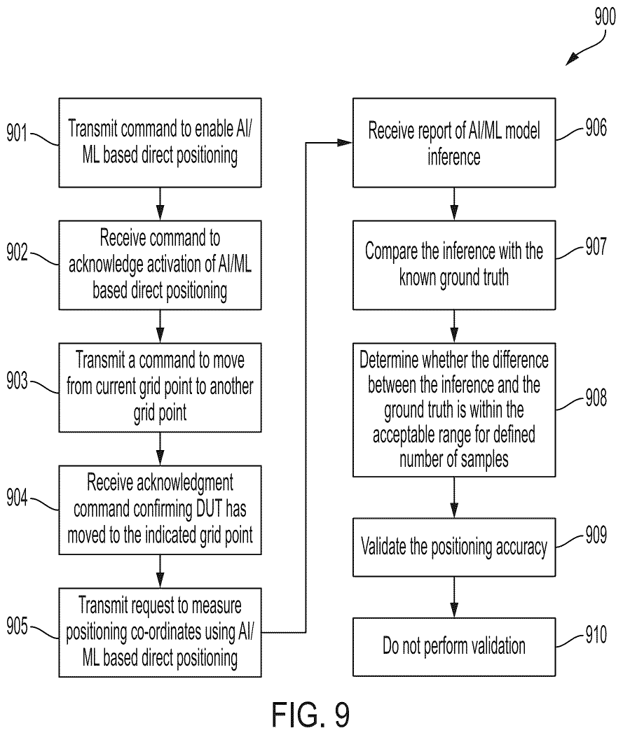

FIG. 9 illustrates an example of a flow diagram of a method 900 that may be performed by a TE, such as NE 1010 or UE 1020, as illustrated in FIG. 10, according to certain example embodiments.

At step 901, the method may include transmitting a command to enable AI/ML based direct positioning.

At step 902, the method may further include receiving a command to acknowledge activation of AI/ML based direct positioning.

At step 903, the method may further include transmitting a command to move from current test point to another test point.

At step 904, the method may further include receiving an acknowledgement command confirming DUT has moved to the indicated test point.

At step 905, the method may further include transmitting request to measure positioning coordinates using AI/ML based direct positioning.

At step 906, the method may further include receiving a report of AI/ML model inference.

At step 907, the method may further include comparing the inference with the known ground truth.

At step 908, the method may further include determining whether the difference between the inference and the ground truth is within the acceptable range for defined number of samples.

At step 909, the method may further include validating the positioning accuracy.

At step 910, the method may further include not performing validation.

In certain example embodiments, a method may include transmitting, by testing equipment, a request to measure location coordinates to a device. The method may further include receiving, by the testing equipment, from the device, a model inference comprising at least one location coordinate. The method may further include receiving, by the testing equipment, from the device, a model inference comprising at least one location coordinate.

In some example embodiments, the testing equipment may include a network entity, a base station, or a user equipment. The device may include a network entity, a base station, or a user equipment, wherein the user equipment may include one or more receivers.

In various example embodiments, the method may include comparing, by the testing equipment, a location coordinate of a first receiver of the user equipment, and a location coordinate of a second receiver of the user equipment.

In certain example embodiments, the method may include adjusting, by the testing equipment, at least one transmission parameter of the testing equipment to simulate a change of position of the device. The at least one transmission parameter may include at least one of transmission occasion, received power, transmission power, propagation delay, or transmission delay.

In some example embodiments, the request to measure location coordinates may be based upon at least one of artificial intelligence based direct positioning or machine learning based direct positioning.

In various example embodiments, the determining may further include comparing, by the testing equipment, the model inference to the at least one ground truth.

In certain example embodiments, the known location coordinate of the test point may include at least one actual location coordinate of the test point.

In some example embodiments, the method may include transmitting, by the testing equipment, a command for the device to move from the test point to another test point, and receiving, by the testing equipment, an acknowledgement confirming that the device has moved to the another test point.

In various example embodiments, a test grid may include at least the test point and the another test point. A granularity of the test grid may be based at least in part on a required positioning accuracy. At least one of a period of time, a starting time, or an ending time may indicate when the device is positioned at the test point. A trajectory of the device may be preconfigured or defined by synchronization signaling.

In certain example embodiments, transmitting, by the testing equipment, at least one of an artificial intelligence inference comprising at least one location coordinate, or a machine learning inference comprising at least one location coordinate. The at least one of an artificial intelligence inference or machine learning inference may be transmitted via synchronization signal or the testing equipment

In some example embodiments, the method may further include transmitting, by the testing equipment, a command to acknowledge activation of at least one of artificial intelligence based direct positioning or machine learning based direct positioning. The command may be transmitted via air interface or an application level command.

In certain example embodiments, the at least one ground truth may include at least one global navigation satellite system based location coordinate.

In some example embodiments, the method may further include transmitting, by the testing equipment, monitoring data comprising at least one model monitoring input. The at least one model monitoring input may include at least one ground truth location.

In various example embodiments, the determining may be performed without a test grid. The determining may be performed based on a global navigation satellite system based location coordinate.

In certain example embodiments, the method may include testing, by the testing equipment, a generalization of the model inference. The testing may be performed using at least one configuration parameter matching at least one parameter in a data set used to train an artificial intelligence or machine learning model. The at least one configuration parameter may include at least one transmitter. Generalization may refer to testing the performance of the ML model in varied conditions, for example, NLOS conditions.

In some example embodiments, the testing equipment may be configured to move based on at least one pre-configured test plan. For example, the at least one pre-configured test plan may define at least one movement pattern across the test grid, and a time period for the testing equipment to remain at a test point. The at least one pre-configured test plan may define a test plan for the device and at least one other device. The device may be configured with an artificial intelligence or machine learning model, and the at least one other device does not use an artificial intelligence or machine learning model.

In certain example embodiments, the method may include comparing, by the testing equipment, a location coordinate of the device and a location coordinate of the at least one other device.

In certain example embodiments, a method may include receiving, by a device, a request to measure location coordinates from testing equipment. The method may further include performing, by the device, one or more direct positioning measurements. The method may further include transmitting, by the device, a model inference comprising at least one location coordinate to the testing equipment.

The device may include a network entity, a base station, or a user equipment. The testing equipment may include a network entity, a base station, or a user equipment.

In some example embodiments, the one or more direct positioning measurements may be performed based on at least one transmission parameter. For example, the at least one transmission parameter may include at least one of transmission occasion, reception power, propagation delay, or transmission delay.

In various example embodiments, the direct positioning may include at least one of artificial intelligence based direct positioning or machine learning based direct positioning.

In certain example embodiments, the method may further include receiving, by the device, a command for the device to move from a test point to another test point, and transmitting, by the device, an acknowledgement confirming that the device has moved to the another test point.

In some example embodiments, the request to measure location coordinates may be based upon at least one of artificial intelligence based direct positioning or machine learning based direct positioning. A test grid may include at least the test point and the another test point. A granularity of the test grid may be based at least in part on a required positioning accuracy. At least one of a period of time, a starting time, or an ending time may indicate when the device is positioned at the test point. A trajectory of the device may be preconfigured or defined by synchronization signaling.

In various example embodiments, the method may further include receiving, by the device, a command to acknowledge activation of at least one of artificial intelligence based direct positioning or machine learning based direct positioning, and transmitting, by the device, an acknowledgement confirming that the device has moved to the another test point. The acknowledgement may be transmitted via air interface or an application level command. At least one ground truth may include at least one global navigation satellite system based location coordinate.

FIG. 10 illustrates an example of a system according to certain example embodiments. In one example embodiment, a system may include multiple devices, such as, for example, NE 1010 and/or UE 1020.

NE 1010 may be one or more of a base station (e.g., 3G UMTS NodeB, 4G LTE Evolved NodeB, or 5G NR Next Generation NodeB), a serving gateway, a server, and/or any other access node or combination thereof.

NE 1010 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 1020 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1010 and/or UE 1020 may be one or more of a citizens broadband radio service device (CBSD).

NE 1010 and/or UE 1020 may include at least one processor, respectively indicated as 1011 and 1021. Processors 1011 and 1021 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1012 and 1022. The memory may be fixed or removable. The memory may include computer program instructions or computer code contained therein. Memories 1012 and 1022 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1011 and 1021, memories 1012 and 1022, and any subset thereof, may be configured to provide means corresponding to the various blocks of FIGS. 1-9. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 10, transceivers 1013 and 1023 may be provided, and one or more devices may also include at least one antenna, respectively illustrated as 1014 and 1024. The device may have many antennas, such as an array of antennas configured for multiple input multiple output (MIMO) communications, or multiple antennas for multiple RATs. Other configurations of these devices, for example, may be provided. Transceivers 1013 and 1023 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-9). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-9. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

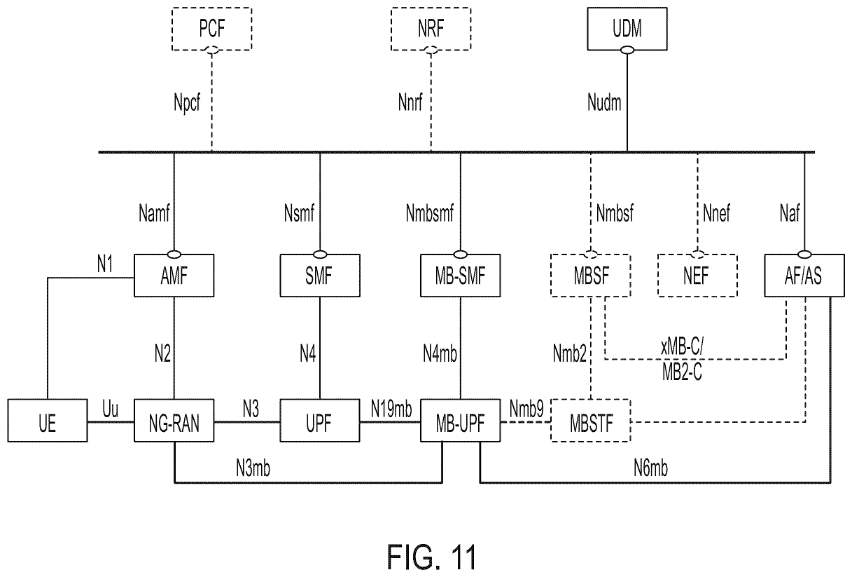

FIG. 11 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 11 may be similar to NE 1010 and UE 1020, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1011 and 1021, and memories 1012 and 1022, may be included in or may form a part of processing circuitry or control circuitry. In addition, in some example embodiments, transceivers 1013 and 1023 may be included in or may form a part of transceiving circuitry.

In some example embodiments, an apparatus (e.g., NE 1010 and/or UE 1020) may include means for performing a method, a process, or any of the variants discussed herein. Examples of the means may include one or more processors, memory, controllers, transmitters, receivers, and/or computer program code for causing the performance of the operations.

In various example embodiments, apparatus 1010 or 1020 may be controlled by memory 1012 and processor 1011 (or memory 1022 and processor 1021) to transmit a request to measure location coordinates to a device, receive from the device, a model inference comprising at least one location coordinate, and determine whether a difference between the model inference and at least one ground truth is within a threshold value for a defined number of samples. The at least one ground truth comprises at least one known location coordinate of a test point.

Certain example embodiments may be directed to an apparatus that includes means for performing any of the methods described herein including, for example, means for transmitting a request to measure location coordinates to a device, means for receiving from the device, a model inference comprising at least one location coordinate, and means for determining whether a difference between the model inference and at least one ground truth is within a threshold value for a defined number of samples. The at least one ground truth comprises at least one known location coordinate of a test point.

In various example embodiments, apparatus 1010 or 1020 may be controlled by memory 1012 and processor 1011 (or memory 1022 and processor 1021) to receive a request to measure location coordinates from testing equipment, perform one or more direct positioning measurements, and transmit a model inference comprising at least one location coordinate to the testing equipment.

Certain example embodiments may be directed to an apparatus that includes means for performing any of the methods described herein including, for example, means for receiving a request to measure location coordinates from testing equipment, means for performing one or more direct positioning measurements, and means for transmitting a model inference comprising at least one location coordinate to the testing equipment.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3rd Generation Partnership Project
5G 5^{th} Generation
5GC 5^{th} Generation Core
6G 6^{th} Generation
AF Application Function
A-GNSS Assisted Global Navigation Satellite System
AI Artificial Intelligence
ASIC Application Specific Integrated Circuit
CBSD Citizens Broadband Radio Service Device
CIR Channel Impulse Response
CPU Central Processing Unit
CU Centralized Unit
DU Distributed Unit
DUT Device Under Test
eMBB Enhanced Mobile Broadband
eNB Evolved Node B
gNB Next Generation Node B
GNSS Global Navigation Satellite System
GPS Global Positioning System
HDD Hard Disk Drive
IoT Internet of Things
KPI Key Performance Indicator
LMF Location Management Function
LoS Line of Sight
LTE Long-Term Evolution
LTE-A Long-Term Evolution Advanced
MEMS Micro Electrical Mechanical System
MIMO Multiple Input Multiple Output
ML Machine Learning
mMTC Massive Machine Type Communication
MSE Mean Square Error
NE Network Entity
NG Next Generation
NG-eNB Next Generation Evolved Node B
NG-RAN Next Generation Radio Access Network
NLoS Non-Line of Sight
NR New Radio
PDA Personal Digital Assistance
PRS Positioning Reference Signal
PRU Positioning Reference Unit
QoS Quality of Service
RAM Random Access Memory
RAN Radio Access Network
RAT Radio Access Technology
RF Radio Frequency
ROM Read-Only Memory
RS Reference Signal
RSRP Reference Signal Received Power
RSTD Reference Signal Time Difference
SS System Simulator
SSB Synchronization Signal Block
TE Test Equipment
TRP Transmission and Reception Point
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network

We claim:

1. An apparatus comprising:
at least one processor; and
at least one memory storing instructions that, when executed by the at least one processor, cause the apparatus at least to:
transmit a request to measure location coordinates to a device;
receive from the device, a model inference comprising at least one location coordinate; and
determine whether a difference between the model inference and at least one ground truth is within a threshold value for a defined number of samples, wherein the at least one ground truth comprises at least one known location coordinate of a test point.

2. The apparatus of claim 1, wherein the apparatus comprises a network entity, a base station, or a user equipment.

3. The apparatus of claim 1, wherein the device comprises a network entity, a base station, or a user equipment.

4. The apparatus of claim 3, wherein the user equipment comprises one or more receivers.

5. The apparatus of claim 4, wherein the at least one memory and the instructions, when executed by the at least one processor, further cause the apparatus at least to:
compare a location coordinate of a first receiver of the user equipment, and a location coordinate of a second receiver of the user equipment.

6. The apparatus of claim 1, wherein the at least one memory and the instructions, when executed by the at least one processor, further cause the apparatus at least to:
adjust at least one transmission parameter of the apparatus to simulate a change of position of the device.

7. The apparatus of claim 1, wherein the request to measure location coordinates is based upon at least one of artificial intelligence based direct positioning or machine learning based direct positioning.

8. The apparatus of claim 1, wherein the at least one memory and the instructions, when executed by the at least one processor, further cause the apparatus at least to:
compare the model inference to the at least one ground truth.

9. The apparatus of claim 1, wherein the known location coordinate of the test point comprises at least one actual location coordinate of the test point.

10. The apparatus of claim 1, wherein the at least one memory and the instructions, when executed by the at least one processor, further cause the apparatus at least to:
transmit a command for the device to move from the test point to another test point.

11. The apparatus of claim 1, wherein at least one of a period of time, a starting time, or an ending time indicates when the device is positioned at the test point.

12. The apparatus of claim 1, wherein a trajectory of the device is preconfigured or defined by synchronization signaling.

13. The apparatus of claim 1, wherein the at least one memory and the instructions, when executed by the at least one processor, further cause the apparatus at least to:
transmit at least one of an artificial intelligence inference comprising at least one location coordinate, or a machine learning inference comprising at least one location coordinate.

14. The apparatus of claim 1, wherein the at least one memory and the instructions, when executed by the at least one processor, further cause the apparatus at least to:
transmit a command to acknowledge activation of at least one of artificial intelligence based direct positioning or machine learning based direct positioning.

15. The apparatus of claim 1, wherein the at least one ground truth comprises at least one global navigation satellite system based location coordinate.

16. The apparatus of claim 1, wherein the at least one memory and the instructions, when executed by the at least one processor, further cause the apparatus at least to:
transmit monitoring data comprising at least one model monitoring input.

17. The apparatus of claim 1, wherein the at least one memory and the instructions, when executed by the at least one processor, further cause the apparatus at least to:
test a generalization of the model inference.

18. The apparatus of claim 17, wherein the testing is performed using at least one configuration parameter matching at least one parameter in a data set used to train an artificial intelligence or machine learning model.

19. An apparatus comprising:
at least one processor; and
at least one memory storing instructions that, when executed by the at least one processor, cause the apparatus at least to:
receive a request to measure location coordinates from testing equipment;
perform one or more direct positioning measurements; and
transmit a model inference comprising at least one location coordinate to the testing equipment.

20. A method comprising:
transmitting, by testing equipment, a request to measure location coordinates to a device;
receiving, by the testing equipment, from the device, a model inference comprising at least one location coordinate; and
determining, by the testing equipment, whether a difference between the model inference and at least one ground truth is within a threshold value for a defined number of samples, wherein the at least one ground truth comprises at least one known location coordinate of a test point.
